(19) United States
(12) Patent Application Publication
(10) Pub. No.: US 2021/0182070 A1
(43) Pub. Date: Jun. 17, 2021

(54) EXPLICIT RESOURCE FILE TO ASSIGN EXACT RESOURCES TO JOB RANKS

(71) Applicant: International Business Machines Corporation, Armonk, NY (US)

(72) Inventors: DAHAI GUO, CHAMPAIGN, IL (US); DAVID GEORGE SOLT, FRISCO, TX (US); JOSHUA J. HURSEY, LA CROSSE, WI (US); AUSTEN WILLIAM LAURIA, WAPPINGERS FALLS, NY (US); XIN GUO, BEIJING CITY (CN)

(21) Appl. No.: 16/710,816

(22) Filed: Dec. 11, 2019

(51) Int. Cl. G06F 9/38; G06T 1/20; H04L 29/08

(52) U.S. Cl. CPC G06F 9/3855; G06F 9/3887; H04L 67/10; G06T 1/20; G06F 9/3889

(57) ABSTRACT

A method uses an explicit resource file (ERF) to repetitively execute a set of processes using consistent resources. The method generates the ERF for a set of processes. The ERF identifies one or more specified central processing units (CPUs), one or more specified graphics processing units (GPUs), and one or more memory ranges in memory to be used by the one or more specified CPUs and the one or more specified GPUs when executing the set of processes. The method enforces compliance with the ERF when repetitively executing the set of processes.

### STATEMENT REGARDING FEDERALLY SPONSORED RESEARCH OR DEVELOPMENT

This invention was made with Government support under Contract No.: B604143 awarded by Lawrence Livermore National Security, LLC. The Government has certain rights in this invention.

### BACKGROUND

The present invention relates to the field of process execution. Still more specifically, the present invention relates to the field of use of an explicit resource file (ERF) when repetitively executing a same set of processes.

### SUMMARY

A method uses an explicit resource file (ERF) to repetitively execute a set of processes using consistent resources. The method generates the ERF for a set of processes. The ERF identifies one or more specified central processing units (CPUs), one or more specified graphics processing units (GPUs), and one or more memory ranges in memory to be used by the one or more specified CPUs and the one or more specified GPUs when executing the set of processes. The method enforces use of the ERF when repetitively executing the set of processes by the one or more specified CPUs and the one or more specified GPUs using the one or more memory ranges in memory. The method places ranks from the set of processes to a specified node, where the specified node includes the one or more specified CPUs and the one or more specified GPUs that are using the one or more memory ranges in memory. The method then binds the ranks from the set of processes for execution by one or more CPUs from the one or more specified CPUs and one or more GPUs from the one or more specified GPUs that are using the one or more memory ranges in memory. The method orders an execution order of the ranks from the set of processes by: providing a unique name to each of the ranks from the set of processes; and establishing the execution order of the ranks from the set of processes. The method then repetitively executes the set of processes by the one or more CPUs from the one or more specified CPUs and the one or more GPUs from the specified GPUs that are using the one or more memory ranges in memory according to the placing, binding, and ordering of the ranks, and an enforced use of the ERF.

In one or more embodiments, the method(s) described herein are performed by an execution of a computer program product and/or a computer system.

### BRIEF DESCRIPTION OF THE DRAWINGS

FIG. 1 depicts an exemplary system and network in which the present invention is implemented in one or more embodiments;

FIG. 2 illustrates an exemplary architecture of nodes/hosts as used in one or more embodiments of the present invention;

FIG. 3 is a high-level flow chart of one or more steps performed in accordance with one or more embodiments of the present invention;

FIG. 4 depicts a cloud computing environment according to one or more embodiments of the present invention; and

FIG. 5 depicts abstraction model layers of a cloud computer environment according to one or more embodiments of the present invention.

### DETAILED DESCRIPTION

In one or more embodiments, the present invention is a system, a method, and/or a computer program product at any possible technical detail level of integration. In one or more embodiments, the computer program product includes a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In one or more embodiments, computer readable program instructions for carrying out operations of the present invention comprise assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. In one or more embodiments, the computer readable program instructions execute entirely on the user's computer, partly on the user's computer, as a stand-alone software package, partly on the user's computer and partly on a remote computer or entirely on the remote computer or server. In the latter scenario and in one or more embodiments, the remote computer connected to the user's computer through any type of network, including a local area network (LAN) or a wide area network (WAN), or the connection is made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

In one or more embodiments, these computer readable program instructions are provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In one or more embodiments, these computer readable program instructions are also stored in a computer readable storage medium that, in one or more embodiments, direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In one or more embodiments, the computer readable program instructions are also loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams represents a module, segment, or portion of instructions, which comprises one or more executable instructions for implementing the specified logical function(s). In some alternative implementations, the functions noted in the block occur out of the order noted in the figures. For example, two blocks shown in succession are, in fact, executed substantially concurrently, or the blocks are sometimes executed in the reverse order, depending upon the functionality involved. It will also be noted that, in one or more embodiments of the present invention, each block of the block diagrams and/or flowchart illustration, and combinations of blocks in the block diagrams and/or flowchart illustration, are implemented by special purpose hardware-based systems that perform the specified functions or acts or carry out combinations of special purpose hardware and computer instructions.

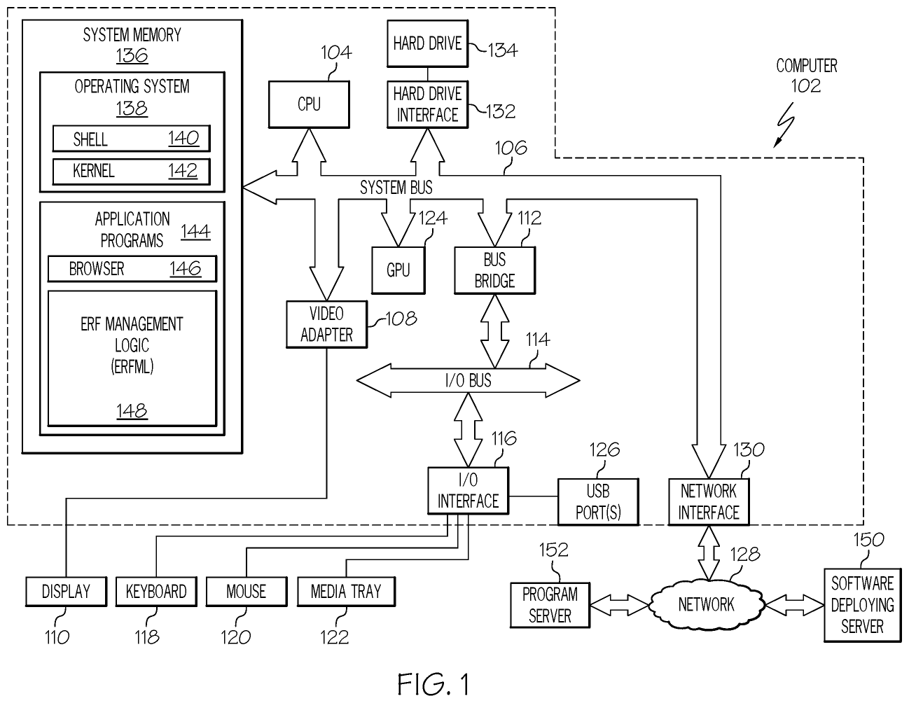

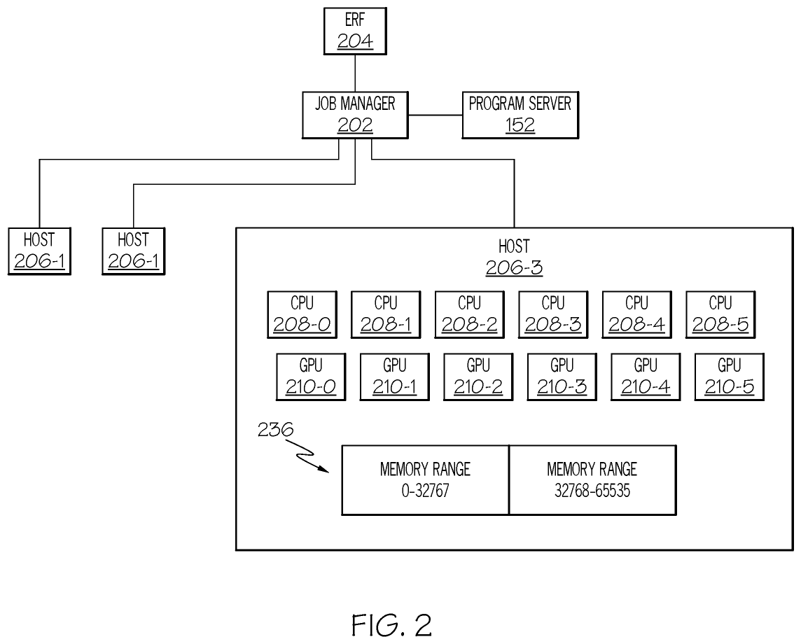

With reference now to the figures, and in particular to FIG. 1, there is depicted a block diagram of an exemplary system and network that can be utilized by and/or in the implementation of the present invention. Note that some or all of the exemplary architecture, including both depicted hardware and software, shown for and within computer 102 can be utilized by software deploying server 150 and/or program server 152 shown in FIG. 1, and/or the job manager 202 and/or one or more of hosts 206-1 through 206-3 depicted in FIG. 2.

Exemplary computer 102 includes a central processing unit (CPU) 104 that is coupled to a system bus 106. CPU 104 can utilize one or more processor cores. A video adapter 108, which drives/supports a display 110, is also coupled to system bus 106.

Also coupled to system bus 106 is a graphics processing unit (GPU) 124, which is a specialized electronic circuit designed to manipulate and alter memory to accelerate the creation of images in a frame buffer intended for output to a display device (e.g., display 110). However, in one or more embodiments of the present invention, GPU 124 is used to rapidly process data streams in order to output binaries that should be consistent for repetitive executions of a same process/program. As described herein, however, these output binaries are not always consistent in the prior art. Thus, one or more embodiments of the present invention addresses this program.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which can include storage devices such as CD-ROM drives, multi-media interfaces, etc.), and external USB port(s) 126. While the format of the ports connected to I/O interface 116 can be any known to those skilled in the art of computer architecture, in one or more embodiments, some or all of these ports are universal serial bus (USB) ports.

As depicted, computer 102 is also able to communicate with software deploying server 150 and/or a program server 152 (described below) using a network interface 130 to a network 128. Network interface 130 is a hardware network interface, such as a network interface card (NIC), etc. Network 128 can be an external network such as the Internet, or an internal network such as an Ethernet or a virtual private network (VPN).

A hard drive interface 132 is also coupled to system bus 106. Hard drive interface 132 interfaces with a hard drive 134. In one or more embodiments, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

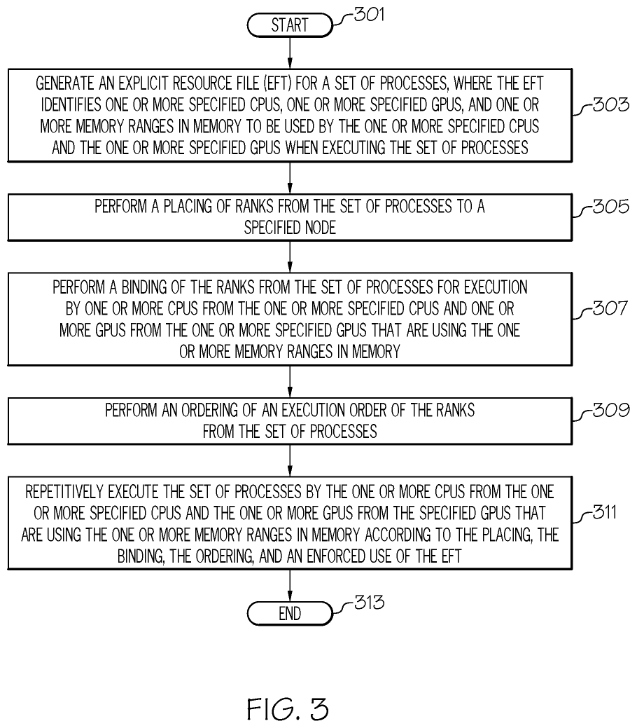

Application programs 144 in computer 102's system memory (as well as software deploying server 150's system memory) also include an Explicit Resource File Management Logic (ERFML) 148. ERFML 148 includes code for implementing the processes described below, including those described in FIGS. 2-3. In one or more embodiments, computer 102 is able to download ERFML 148 from software deploying server 150, including in an on-demand basis, wherein the code in ERFML 148 is not downloaded until needed for execution. Note further that, in one or more embodiments of the present invention, software deploying server 150 performs all of the functions associated with the present invention (including execution of ERFML 148), thus freeing computer 102 from having to use its own internal computing resources to execute ERFML 148.

In one or more embodiments of the present invention, program server 152 serves multiple copies of a same set of processes, which are then executed using the ERF as described herein. In one or more embodiments of the present invention, computer 102 and program server 152 are a same computer.

Note that the hardware elements depicted in computer 102 are not intended to be exhaustive, but rather are representative to highlight essential components required by the present invention. For instance, computer 102 can include alternate memory storage devices such as magnetic cassettes, digital versatile disks (DVDs), Bernoulli cartridges, and the like. These and other variations are intended to be within the spirit and scope of the present invention.

High-performance computing (HPC) systems utilize parallel processing for running advanced application programs efficiently, reliably and quickly. To meet the needs of scientific research and engineering simulations, supercomputers are growing at an unrelenting rate.

To gain maximum performance, the user will often need to assign specific resources to each of the processes within a job—such as central processing units (CPUs), graphics processing units (GPUs), and memory ranges. The processes that make up a set processes (also referred to as a job) are often called ranks. An explicit resource file (ERF) allows the user to assign specific resources to each rank. The resource manager (e.g., an operating system) will then interpret the ERF file, and assign the resources as specified in the ERF file.

As used herein, a “rank” is defined as a specific process within a set of processes. A “process” is defined as a group of instructions. A “set of processes” is defined as software program/programs that are being executed in parallel with each other.

This process can be especially useful when the user wants to assign irregular, or heterogeneous resources to specific ranks within a job. This is also useful for reproducibility. Users often want to compare two programs to see which executes faster using exactly the same resources. Since performance can be influenced by details such as the exact CPUs each process is executing on, it is important for users to be able to execute a job in exactly the same way every time it is executed.

The prior art does not provide a solution to this need/problem/issue. Rather, job launchers currently provide a command line interface to allocate resources, how to group those resources, and how to assign those processes to groupings of resources. However, these interfaces provide only heterogeneous resource allocations (i.e., they allocate different types of resources, which vary during each allocation).

Furthermore, current job launchers have a number of command line options to describe hardware resources and can use a file to specify the ordering of processes as they are assigned to the resources described by the command line options. However, this file is unlike the invention described herein in that it does not specifically define/identify particular resources for use, and thus does not provide a way to map the same processes to identical resources.

As described herein, an explicit resource file (ERF) is a formatted file that is read or written directly by the job manager. In one or more embodiments of the present invention, the ERF itself is specified by a command line option or any other option that users use to influence the job manager. For example, if a job manager were using mpirun (a shell script for starting jobs), the user could use the following command line to generate an ERF file:
mpirun -np 2 --erf output=./job_info hello_world

The “job_info” file will contain the specific resources assigned to each “hello_world” rank. For future runs, the user would only need to specify --erf input to use the exact same resources for another execution of the hello_world application:
mpirun --np 2 --erf input=./job_info

An example erf format file is as follows:

app 0: hello_world
overlapping-rs: warn
oversubscribe_cpu: warn
oversubscribe_mem: allow
oversubscribe_gpu: allow
launch_distribution: cyclic
rank: 0: {host: 1; cpu: {0-2}; gpu: [0-2}; mem: {0-32767}: app 0
rank: 1: {host: 1; cpu: {3-5}; gpu: [3-5}; mem: {32768-65535}: app 0

From the above example, rank 0 of the hello_world application would be assigned logical CPUs 0-2, logical GPUs 0-2, and a range of memory from 0-32767, and rank 1 of the hello_world application would be assigned logical CPUs 3-5, logical GPUs 3-5, and a range of memory from 32768-65535. The above can be used as input to the job launcher command to launch two “hello_world” processes (rank 0 and rank 1).

That is, with reference to FIG. 2, assume that the job manager 202 has access to an ERF file 204, which specifies not only which CPU's (e.g., one or more of CPUs 208-0 through 208-5) to use when executing a specific set of instructions (ranks/processes from the job), but also specifies 1) which host from host 206-1 through host 206-3 to use; 2) which GPU's (e.g., one or more of GPUs 210-0 through 210-5) to use within a selected host (e.g., host 206-3, whose architecture is similar to that of host 206-1 and host 206-2), and 3) which memory range (e.g., memory addresses in the range of 0-32767 or memory addresses in the range of 32768-65535) in a memory 236 (analogous to system memory 136 shown in FIG. 1) to use when repetitively executing a same set of processes (e.g., software code) that it receives from the program server 152 introduced in FIG. 1.

In one or more embodiments of the present invention, the different hosts (e.g., host 206-1 and host 206-3) share one or more of the CPUs 208-1 to 208-5, one or more of the GPUs 210-0 to 210-5, and/or the memory 236.

In one or more embodiments of the present invention, the different hosts (e.g., host 206-1 and host 206-3) have their own unique CPUs, GPUs, and memory that are not shared with any other host.

In one or more embodiments of the present invention, the novel ERF file described herein has the following features that improve the operation of a computer.

First, and in one or more embodiments of the present invention, the novel ERF file allows for regular and/or arbitrary rank placing, binding, and ordering in a job. In one or more embodiments, the ERF assigns, to different ranks, different numbers of the CPUs, GPUs, and memory. In one or more embodiments, each rank is assigned any available resources on the same node.

Furthermore, and in one or more embodiments of the present invention, the novel ERF enables users to specify the rank layout of both single process multiple data (SPMD) and multiple process multiple data (MPMD) applications. That is, in one or more embodiments of the present invention, multiple applications (SPMD, MPMD, and/or a combination thereof) are allowed in the same ERF, and different applications can be assigned to different sets of resources.

Furthermore, and in one or more embodiments of the present invention, the novel ERF allows hosts to be specified by logical names (e.g., 0, 1, 2) or actual names (e.g., nodeA, nodeB, nodeC), and ranges of memory.

Furthermore, and in one or more embodiments of the present invention, physical or logical indices for CPUs are described in the ERF. In one or more embodiments of the present invention, physical and/or operating system indices and logical indices are different for the CPUs and/or simultaneous multithreading (SMT) on the same node (e.g., host 206-3 shown in FIG. 2). Thus, the presently-described ERF allows users to use either physical or logical indices for CPU/SMT bindings.

Furthermore, and in one or more embodiments of the present invention, ranks (processes within a set of processes) are either explicitly assigned to sets of resources or are assigned using a pattern such as cyclic, packed or plane.

Furthermore, and in one or more embodiments of the present invention, allocated CPUs, GPUs, and memory ranges are either private or shared between ranks. In one or more embodiments of the present invention, the user specifies if sharing is permitted within the file. Depending on user's choices, warning/error messages can be printed when the job launcher detects that a resource is shared between two or more ranks/processes (i.e., there is an over-subscription of the resource).

With reference now to FIG. 3, a high-level flow chart of one or more steps performed in accordance with one or more embodiments of the present invention is presented.

After initiator block 301, the method generates an explicit resource file (ERF) for a set of processes, as described in block 303. The ERF identifies one or more specified central processing units (CPUs), one or more specified graphics processing units (GPUs), and one or more memory ranges in memory to be used by the one or more specified CPUs and the one or more specified GPUs when executing the set of processes. Use of the ERF is enforced when repetitively executing the set of processes. That is, this ERF not only identifies which CPU(s) are to be used when executing a set of processes, but also identifies which GPU(s) and memory ranges are to be used. Thereafter, when repeatedly executing the same set of processes, the system demands that the ERF be followed. If the ERF is not complied with, then in one or more embodiments of the present invention, the job manager 202 shown in FIG. 2 will stop the execution of the processes/program that it obtained for repetitive execution.

As described in block 305, the method performs a process of placing ranks from the set of processes to a specified node, where the specified node includes the one or more specified CPUs and the one or more specified GPUs that are using the one or more memory ranges in memory. That is, the job manager divides the entire set of processes into smaller units (called ranks), and then places these smaller subsets into specific node(s) (e.g., one or more of the hosts 206-1 to 206-3 shown in FIG. 2).

As described in block 307, the method performs a process of binding the ranks from the set of processes for execution by one or more CPUs from the one or more specified CPUs and one or more GPUs from the one or more specified GPUs that are using the one or more memory ranges in memory. That is, the job manager 202 in FIG. 2 identifies, by referencing the ERF 204, which specific CPUs, GPUs, and memory range is permissible to use when executing particular ranks from the set of processes.

As described in block 309, the method performs an ordering of an execution order of ranks from the set of processes by: providing a unique name to each of the ranks from the set of processes; and establishing the execution order of the ranks from the set of processes. That is, this ordering operation 1) gives a unique name to each rank from the set of processes, and 2) states whether the execution of the ranks will be sequential (run in the order that they occur in the program) or cyclic (e.g., executing every second rank and then looping back to execute previously unexecuted ranks).

In one or more embodiments of the present invention, the placing, the binding, and the ordering of the ranks described above are specified in the ERF.

As described in block 311, the method then repetitively executes the set of processes by the one or more CPUs from the one or more specified CPUs and the one or more GPUs from the specified GPUs that are using the one or more memory ranges in memory according to the placing, binding, and ordering of the ranks, and an enforced use of the ERF. That is, the job manager permits the hosts shown in FIG. 2 to repetitively execute a same set of processes/instructions if the placing, binding, and ordering just described is used, and if the CPU/GPU/memory ranges described in the ERF are used.

The flow-chart ends at terminator block 313.

In one or more embodiments of the present invention, the outputs from repetitive executions of the set of processes using different ERFs are compared, in order to determine which ERF is best. That is, if a first ERF that uses a first set of CPUs, GPUs, memory ranges, as well as a first set of placing, binding, and ordering of ranks, produces outputs from repetitive execution of a set of processes (e.g., 100 runs) that match up exactly 95% of the time, but a second ERF that uses a second set of CPUs, GPUs, memory ranges, as well as a second set of placing, binding, and ordering of ranks, produces outputs from repetitive execution of that same set of processes (e.g., 100 runs) that match up exactly 99% of the time, then the second ERF is superior to the first ERF, and will be used in the future when repetitively executing that set of processes (e.g., for testing that set of processes).

In one or more embodiments of the present invention, physical indices (i.e., names) are used by the ERF to identify which CPUs and/or GPUs are used to reiteratively execute a same set of instructions.

In one or more embodiments of the present invention, logical indices (i.e., logical positions in a node) are used by the ERF to identify which CPUs and/or GPUs are used to reiteratively execute a same set of instructions.

In one or more embodiments of the present invention, the allocated CPUs, GPUs, and memory described in the ERF are private (i.e., found in only a single node, such as host 206-3 shown in FIG. 2)

In one or more embodiments of the present invention, the allocated CPUs, GPUs, and memory described in the ERF are shared (i.e., are shared by multiple nodes shown in FIG. 2).

In one or more embodiments of the present invention, the placing, the binding, and the ordering of the ranks described above are specified in the ERF.

In one or more embodiments of the present invention, the method explicitly assigns individual ranks from the set of processes to specific resources using a non-sequential pattern. For example, ranks numbered 1, 2, 3, 4 are assigned to resources A and B (e.g., particular GPUs) such that ranks 1, 3 are assigned to resource A, and ranks 2, 4 are assigned to resource B, even though the ranks 1, 2, 3, 4 are found in the set of processes in that order.

In one or more embodiments of the present invention, the method executes ranks from the set of processes either serially or cyclically. That is, if serial execution (in which ranks are executed in the order in which they are found in the set of processes) produces consistent outputs when repetitively executing a set of processes, then that set of processes are executed serially in the future. However, if cyclic execution (in which ranks are executed out of order) produces a more consistent output, then that set of processes are executed cyclically in the future.

In one or more embodiments of the present invention, the set of processes is a single program multiple data (SPMD) program. That is, the program is split up into multiple parts, each of which can execute simultaneously on different nodes according to the allocated resources named in the ERF.

In one or more embodiments of the present invention, the set of processes is a multiple program multiple data (MPMD) program. That is, multiple different programs are able to be executed simultaneously by using the allocated resources name in the ERF.

In one or more embodiments of the present invention, the method assigns multiple sets of processes to a single GPU from the specified GPUs, where assigning the multiple sets of processes to the single GPU causes the single GPU to be an oversubscribed GPU; and issues a warning to a user that the single GPU is oversubscribed. That is, if multiple sets of processes use a same GPU, then that GPU is no longer dedicated to just a single set of processes, and it deemed to be oversubscribed, thus possibly leading to a decrease in that GPU's ability to produce consistent results whenever involved in the execution of those multiple sets of processes.

In one or more embodiments of the present invention, the method assigns multiple ranks to a single GPU from the specified GPUs, where assigning the multiple ranks to the single GPU causes the single GPU to be an oversubscribed GPU; and issues a warning to a user that the single GPU is oversubscribed. That is, if multiple ranks use a same GPU, then that GPU is no longer dedicated to just a single rank, and it deemed to be oversubscribed, thus possibly leading to a decrease in that GPU's ability to produce consistent results whenever involved in the execution of the set of processes that contains that rank.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references one or more particular CPUs to be used during the repetitively executing of the set of processes, while also using the placing, the binding, the ordering, and the enforced use of the ERF as described above.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references one or more particular GPUs to be used during the repetitively executing of the set of processes, while also using the placing, the binding, the ordering, and the enforced use of the ERF as described above.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references the memory ranges of the memory to be used during the repetitively executing of the set of processes, while also using the placing, the binding, the ordering, and the enforced use of the ERF as described above.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references a combination of one or more particular CPUs and one or more particular GPUs to be used during the repetitively executing of the set of processes, while also using the placing, the binding, the ordering, and the enforced use of the ERF as described above.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references a combination of one or more particular CPUs and the memory range in memory to be used during the repetitively executing of the set of processes, while also using the placing, the binding, the ordering, and the enforced use of the ERF as described above.

While one or more embodiments of the present invention have been presented above in which the ERF designates/references one or more CPUs, one or more GPUs, and one or more memory ranges in memory to be used during the repetitively executing of the set of processes, in one or more other embodiments of the present invention the ERF only designates/references a combination of one or more particular GPUs and the memory range in memory to be used during the repetitively executing of the set of processes, while also using the placing, the binding, the ordering, and the enforced use of the ERF as described above.

In one or more embodiments, the present invention is implemented using cloud computing. Nonetheless, it is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model includes at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but still is able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. In one or more embodiments, it is managed by the organization or a third party and/or exists on-premises or off-premises.

Community cloud: the cloud infrastructure is shared by several organizations and supports a specific community that has shared concerns (e.g., mission, security requirements, policy, and compliance considerations). In one or more embodiments, it is managed by the organizations or a third party and/or exists on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

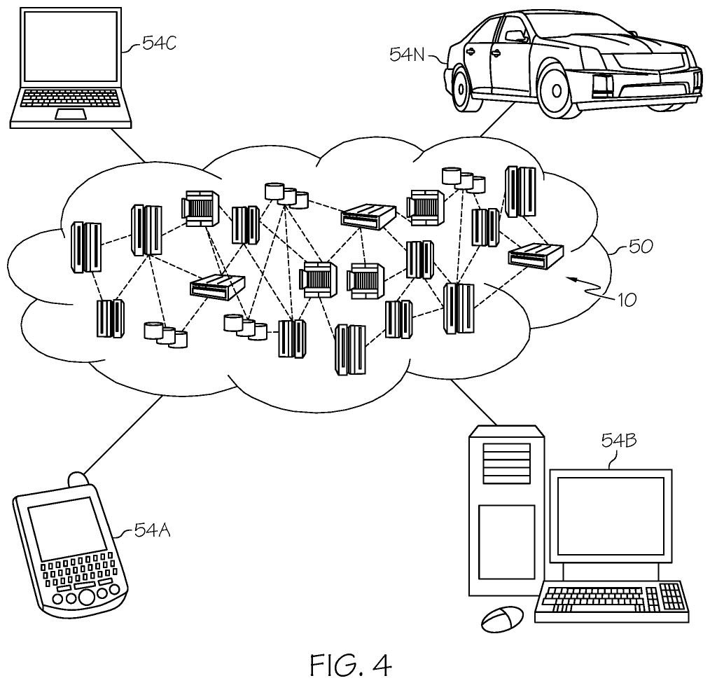

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N communicate with one another. Furthermore, nodes 10 communicate with one another. In one embodiment, these nodes are grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 4 are intended to be illustrative only and that computing nodes 10 and cloud computing environment 50 can communicate with any type of computerized device over any type of network and/or network addressable connection (e.g., using a web browser).

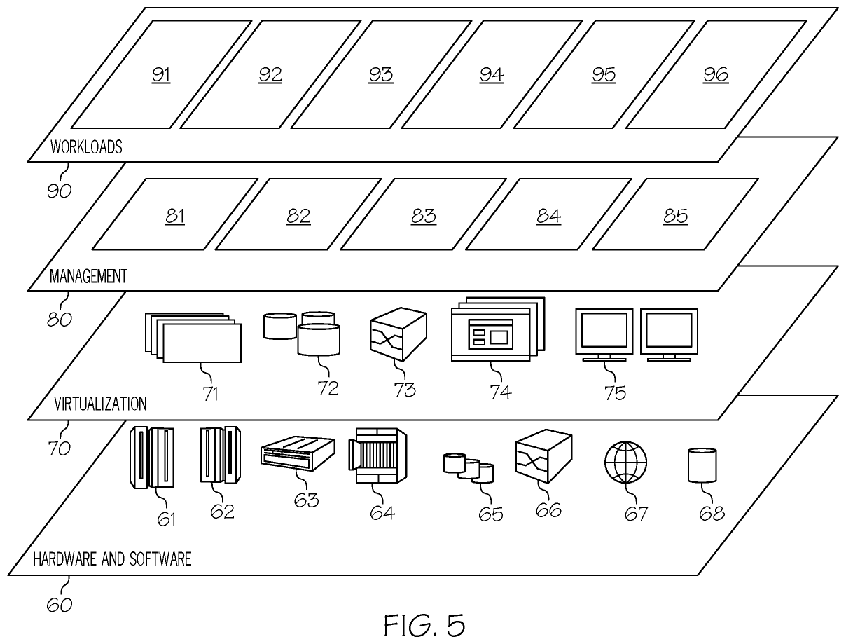

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities that are provided in one or more embodiments: virtual servers 71; virtual storage 72; virtual networks 73, including virtual private networks; virtual applications and operating systems 74; and virtual clients 75.

In one example, management layer 80 provides the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment are utilized in one or more embodiments. Examples of workloads and functions which are provided from this layer include: mapping and navigation 91; software development and lifecycle management 92; virtual classroom education delivery 93; data analytics processing 94; transaction processing 95; and explicit resource file management processing 96, which performs one or more of the features of the present invention described herein.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

In one or more embodiments of the present invention, any methods described in the present disclosure are implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, in one or more embodiments of the present invention any software-implemented method described herein is emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method comprising:
generating an explicit resource file (ERF) for a set of processes, wherein the ERF identifies one or more specified central processing units (CPUs), one or more specified graphics processing units (GPUs), and one or more memory ranges in memory to be used by the one or more specified CPUs and the one or more specified GPUs when executing the set of processes, and wherein use of the ERF is enforced when repetitively executing the set of processes;
placing ranks from the set of processes to a specified node, wherein the specified node comprises the one or more specified CPUs and the one or more specified GPUs that are using the one or more memory ranges in memory;
binding the ranks from the set of processes for execution by one or more CPUs from the one or more specified CPUs and one or more GPUs from the one or more specified GPUs that are using the one or more memory ranges in memory;
ordering an execution order of the ranks from the set of processes by:
providing a unique name to each of the ranks from the set of processes; and
establishing the execution order of the ranks from the set of processes; and
repetitively executing the set of processes by the one or more CPUs from the one or more specified CPUs and the one or more GPUs from the specified GPUs that are using the one or more memory ranges in memory according to the placing, the binding, the ordering, and an enforced use of the ERF.

2. The method of claim 1, wherein the placing, the binding, and the ordering are specified in the ERF.

3. The method of claim 1, further comprising:
explicitly assigning individual ranks from the set of processes to specific resources using a non-sequential pattern.

4. The method of claim 1, wherein the set of processes is a single program multiple data (SPMD) program.

5. The method of claim 1, wherein the set of processes is a multiple program multiple data (MPMD) program.

6. The method of claim 1, further comprising:
assigning multiple sets of processes to a single GPU from the specified GPUs, wherein assigning the multiple sets of processes to the single GPU causes the single GPU to be an oversubscribed GPU; and
issuing a warning to a user that the single GPU is oversubscribed.

7. A computer program product comprising a computer readable storage medium having program code embodied therewith, wherein the computer readable storage medium is not a transitory signal per se, and wherein the program code is readable and executable by a processor to cause the processor to perform a method comprising:
generating an explicit resource file (ERF) for a set of processes, wherein the ERF identifies one or more specified central processing units (CPUs), one or more specified graphics processing units (GPUs), and one or more memory ranges in memory to be used by the one or more specified CPUs and the one or more specified GPUs when executing the set of processes, and wherein use of the ERF is enforced when repetitively executing the set of processes;
placing ranks from the set of processes to a specified node, wherein the specified node comprises the one or more specified CPUs and the one or more specified GPUs that are using the one or more memory ranges in memory;
binding the ranks from the set of processes for execution by one or more CPUs from the one or more specified CPUs and one or more GPUs from the one or more specified GPUs that are using the one or more memory ranges in memory;
ordering an execution order of the ranks from the set of processes by:
providing a unique name to each of the ranks from the set of processes; and
establishing the execution order of the ranks from the set of processes; and
repetitively executing the set of processes by the one or more CPUs from the one or more specified CPUs and the one or more GPUs from the specified GPUs that are using the one or more memory ranges in memory according to the placing, the binding, the ordering, and an enforced use of the ERF.

8. The computer program product of claim 7, wherein the placing, the binding, and the ordering are specified in the ERF.

9. The computer program product of claim 7, wherein the method further comprises:
explicitly assigning individual ranks from the set of processes to specific resources using a non-sequential pattern.

10. The computer program product of claim 7, wherein the set of processes is a single program multiple data (SPMD) program.

11. The computer program product of claim 7, wherein the set of processes is a multiple program multiple data (MPMD) program.

12. The computer program product of claim 7, wherein the method further comprises:
assigning multiple sets of processes to a single GPU from the specified GPUs, wherein assigning the multiple sets of processes to the single GPU causes the single GPU to be an oversubscribed GPU; and
issuing a warning to a user that the single GPU is oversubscribed.

13. The computer program product of claim 7, wherein the program code is provided as a service in a cloud environment.

14. A computer system comprising one or more processors, one or more computer readable memories, and one or more computer readable non-transitory storage mediums, and program instructions stored on at least one of the one or more computer readable non-transitory storage mediums for execution by at least one of the one or more processors via at least one of the one or more computer readable memories, the stored program instructions executed to cause the one or more processors to perform a method comprising:
generating an explicit resource file (ERF) for a set of processes, wherein the ERF identifies one or more specified central processing units (CPUs), one or more specified graphics processing units (GPUs), and one or more memory ranges in memory to be used by the one or more specified CPUs and the one or more specified GPUs when executing the set of processes, and wherein use of the ERF is enforced when repetitively executing the set of processes;
placing ranks from the set of processes to a specified node, wherein the specified node comprises the one or more specified CPUs and the one or more specified GPUs that are using the one or more memory ranges in memory;
binding the ranks from the set of processes for execution by one or more CPUs from the one or more specified CPUs and one or more GPUs from the one or more specified GPUs that are using the one or more memory ranges in memory;
ordering an execution order of the ranks from the set of processes by:
providing a unique name to each of the ranks from the set of processes; and
establishing the execution order of the ranks from the set of processes; and
repetitively executing the set of processes by the one or more CPUs from the one or more specified CPUs and the one or more GPUs from the specified GPUs that are using the one or more memory ranges in memory according to the placing, the binding, the ordering, and an enforced use of the ERF.

15. The computer system of claim 14, wherein the placing, the binding, and the ordering are specified in the ERF.

16. The computer system of claim 14, wherein the method further comprises:
explicitly assigning individual ranks from the set of processes to specific resources using a non-sequential pattern.

17. The computer system of claim 14, wherein the set of processes is a single program multiple data (SPMD) program.

18. The computer system of claim 14, wherein the set of processes is a multiple program multiple data (MPMD) program.

19. The computer system of claim 14, wherein the method further comprises:
assigning multiple sets of processes to a single GPU from the specified GPUs, wherein assigning the multiple sets of processes to the single GPU causes the single GPU to be an oversubscribed GPU; and
issuing a warning to a user that the single GPU is oversubscribed.

20. The computer system of claim 14, wherein the stored program instructions are provided as a service in a cloud environment.
